(19) United States
(12) Patent Application Publication
(10) Pub. No.: US 2005/0151848 A1
(43) Pub. Date: Jul. 14, 2005

(54) Image transmitter

(76) Inventors: Jean Wang, Taipei Hsien (TW); Walter Tsai, Taipei Hsien (TW)

Correspondence Address: BIRCH STEWART KOLASCH & BIRCH, PO BOX 747, FALLS CHURCH, VA, 22040-0747, US

(21) Appl. No.: 10/753,436

(22) Filed: Jan. 9, 2004

(51) Int. Cl. H04N 5/225

(52) U.S. Cl. 348/207.1

(57) ABSTRACT

An image transmitter follows a command signal issued by a computer at a remote end and then controls an image sensor through original wiring. The image transmitter includes an image converting unit, an image compressing unit, a packet processing unit and a communication modulating/demodulating unit. The image converting unit converts the image signal picked up by the image sensor to digital image data. The image compressing unit receives the digital image data and then compressing the digital image data by utilizing image compressing technology. The packet processing unit packs the compressed digital image data to a packet of the image data. The communication modulating/demodulating unit transmits the packet of the image data through the original wiring to the computer at the remote end by frequency modulation. The image transmitter further includes a control unit for controlling the image sensor.

### FIELD OF THE INVENTION

The present invention relates to an image transmitter and more particularly to an image transmitter for transmitting and controlling image data by utilizing an image data packet with radio frequency modulation and existing wiring with a packet mode.

### BACKGROUND OF THE INVENTION

A typical example that is known is onsite security video cameras; at image sensor remote end is an image monitoring system, such as a video display to show images from various cameras. A single controller at the monitoring site controls what images are displayed at which time. Due to the distances involved between many remote cameras and the monitoring site, it seems impractical to hardwire enough cable to cover each camera. The problems of wiring and applications of the prior art areas follows:

1. FIGS. 1A and 1B depict a conventional setup that uses coaxial cable, wherein the image that is picked up by any video camera 11 is transmitted to a computer 13 and an output device 14 (monitor) through a coaxial cable 12. If there are N sets of video cameras 111 to be installed, there is the same quantity of the coaxial cables 12. This method uses the most amounts of e cables and increases the cost of construction; in addition, when transmitting over a large distance, the modulated image is susceptible to interference. For the above reason, there are additional amplifiers 15 to be installed every n meters (the interval is about each 100˜200 meters) for amplifying image signal and the corresponding construction mode is difficult. When the image data is transmitted, there are no serious problems transmitting typical characters through conventional coaxial cable, but transmitting highly complex image data is easy to corrupt and transmits very slowly. During transmission, there are also noise, impulse and electromagnetic disturbance to distort the image data. Furthermore, according to general analogy modulation, it is quite easy to be picked up or alter the image data midway.

2. As shown in FIG. 2, it depicts the wiring mode of optical fibers, and the wiring arrangement of the optical fiber is the same as that of above-mentioned coaxial cable. Optical fiber improves upon the disadvantages of coaxial cable having the most efficient transmitting quality and speed in the recent technology. The optical fiber 16 is also called as a light guiding fiber. The optical fiber 16 is thin and flexible medium for transmitting a beam of light and consists of a plurality of fibers. The optical fiber 16 is the most efficient transmitting medium for transmitting the image data. Although the transmitting quality of optical fiber is the best, construction costs of optical fiber networks do not meet the requirements of the public. Furthermore, during construction and maintenance a special instrument must be used to inspect the fiber. The special instrument is can cost millions of N.T. dollars.

As described above, the transmitting quality of the wiring mode of conventional axial cable 12 is easy to become distorted; the wiring mode of the optical fiber 16 has expensive construction and maintenance.

Accordingly, there exists a need for an image transmitter to solve the afore-mentioned problems.

### SUMMARY OF THE INVENTION

It is an object of the present invention to provide an image transmitter that can protect image data during transmission by utilizing digital image data, the modulating mode of radio frequencies and the transmitting mode of electrical power wiring.

It is another object of the present invention to provide an image transmitter that transmits image data by utilizing original wiring (such as electrical power wiring) and not new wiring, thus making it possible to change the installation position at any time, therefore giving high mobility.

It is further object of the present invention to provide an image transmitter that simultaneously connects to a plurality of video cameras. When connected to the video cameras and network, the image transmitter provides a plurality of IP addresses for remote control. Although conventional video camera networks have a similar function, the conventional video camera network does not transmit image data over long distances without using other more costly types of wiring.

In order to achieve the foregoing objects, the present invention provides an image transmitter for following a command issued by a computer at a remote end and then controlling an image sensor through original wiring. The image transmitter includes an image converting unit, an image compressing unit, a packet processing unit and a communication modulating/demodulating unit. The image converting unit converts the image signal from the image sensor to digital image data. The image compressing unit receives the digital image data and then compresses the digital image data by using standard image compression technology. The packet processing unit packs the compressed digital image data to a packet of image data. The communication modulating/demodulating unit transmits the packet of the image data through existing wiring to a computer at the remote end by frequency modulation. The image transmitter further includes a control unit to instruct the image sensor.

The image transmitter of the present invention converts, compresses, modulates, and then transmits the image data using existing wiring. During transmission, the image transmitter provides the image data with encryption and protection against intercepting or altering image data at a midway. The image transmitter transmits the image data to the receiving end safely, fast and completely.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a block schematic diagram of axial cables wiring arrangement in the prior art.

FIG. 1B is a block schematic diagram of axial cables wiring arrangement in long distance in the prior art.

FIG. 2 is a block schematic diagram of optical fibers wiring arrangement in the prior art.

FIG. 3A is a block schematic diagram of an image transmitter according to a preferred embodiment of the present invention.

FIG. 3B is a block schematic diagram of an image transmitter according to another preferred embodiment of the present invention.

FIG. 4 is a block schematic diagram of an image transmitter according to another preferred application of the present invention.

### DETAILED DESCRIPTION OF THE PREFERRED EMBODIMENTS

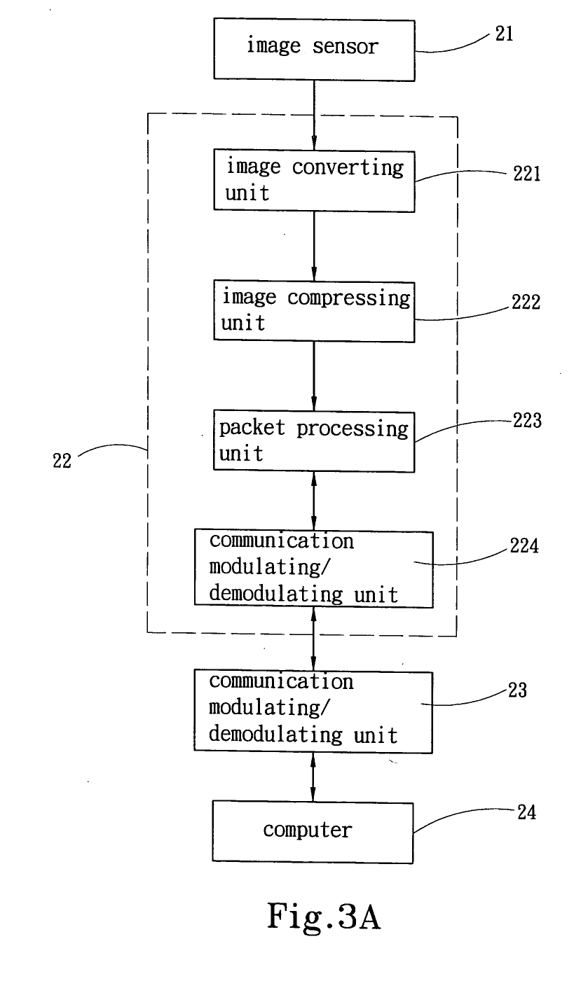

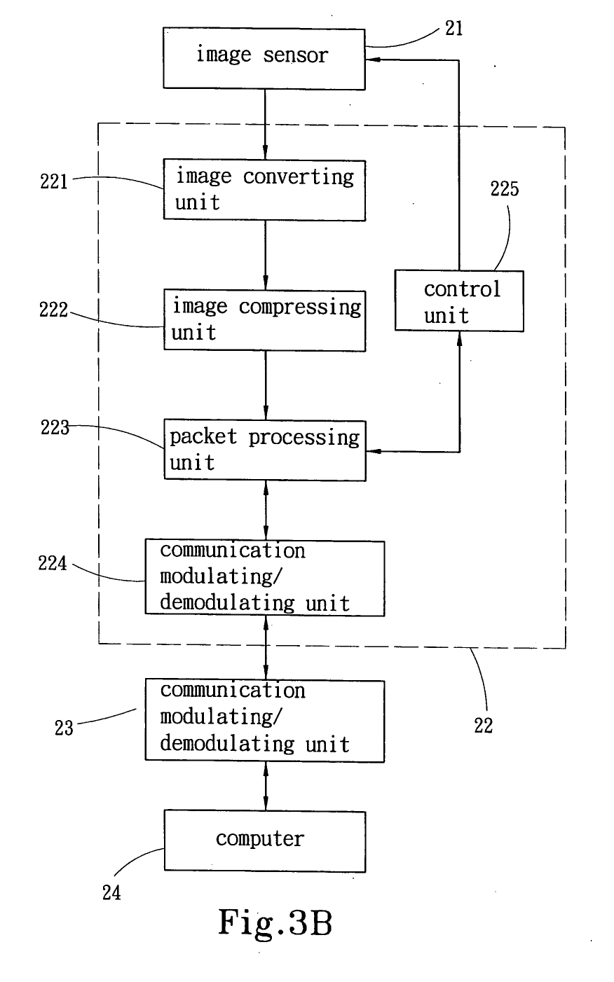

Referring to FIG. 3A, it shows a preferred embodiment of the present invention, wherein image signals are picked up by an image sensor 21 (such as a video camera network having IP addresses), processed by an image transmitter 22, and transmitted from a communication modulating/demodulating unit 23 to a computer 24 at a remote end by using existing wiring (such as electrical power wiring, coaxial cables, telephone wiring, and the like). The image transmitter 22 includes an image converting unit 221, an image compressing unit 222, a packet processing unit 223 and a communication modulating/demodulating unit 224.

The image converting unit 221 converts the image signals picked up by the image sensor 21 to digital image data.

The image compressing unit 222 receives the digital image data and then compresses the digital image data using image compressing technology, to decrease the digital image data size and increase transmission efficiency.

A packet processing unit 223 encapsulates image data or commands during transmission, appending the compressed digital image data to a packet. It also works to strip received data to separate into commands and image data.

A communication modulating/demodulating unit 224 modulates the packet of the image data by means of frequency modulation, so as to transmit the image data over long distances. After modulation, the frequency of the image data is 20 MHz, the image data can be transmitted through existing wiring (such as electrical power wiring), thus no extra installation required. The transmission speed is extremely fast at 14 Mbps. The transmitted image data is demodulated by another communication modulating/demodulating unit 23 and then transmitted to the computer 24 at a terminal end. The communication modulating/demodulating unit 224 provides the capacity of data with 16 bits.

Referring to FIG. 3B, it shows another preferred embodiment of the present invention, wherein a computer 24 at a terminal end is mainly controls an image sensor 21 at a remote end through existing wiring (such as electrical power wiring). A control unit 225 is follows commands issued by the computer 24 and then controls the image sensor 21, such as the control of the depth of field or the focal distance. The command generated by the computer 24 is transmitted through the communication modulating/demodulating units 224, 23 by means of the packet mode of command, and then transmitted to the packet processing unit 223 to unpack the data packet. Thus, command signals in the command packets are transmitted to the control unit 225 which then follows the contents of the command signal to control the image sensor 21, such as monitoring angle, depth of field or the focal distance.

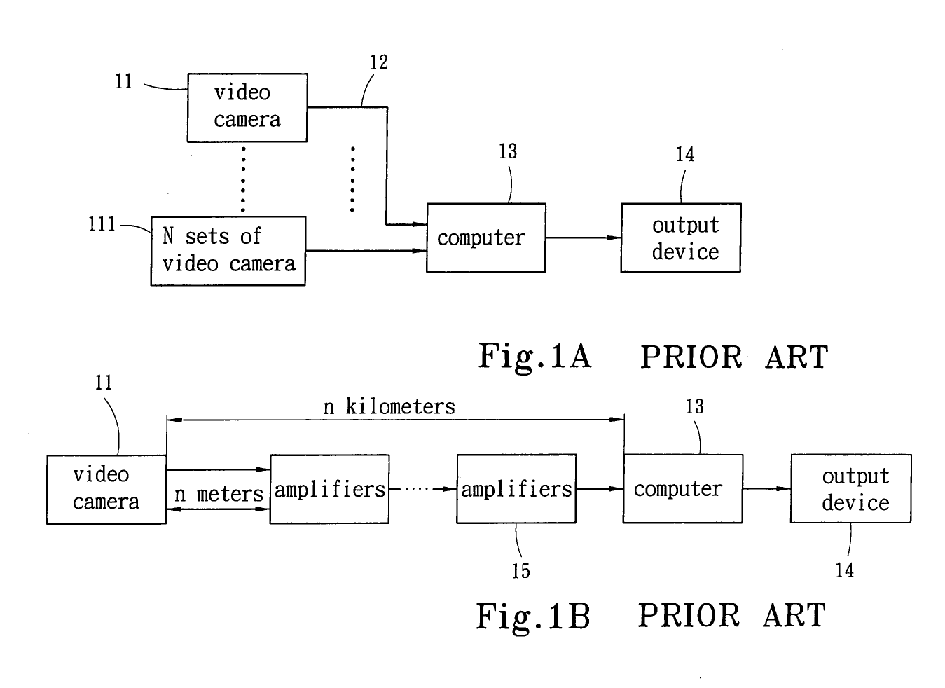

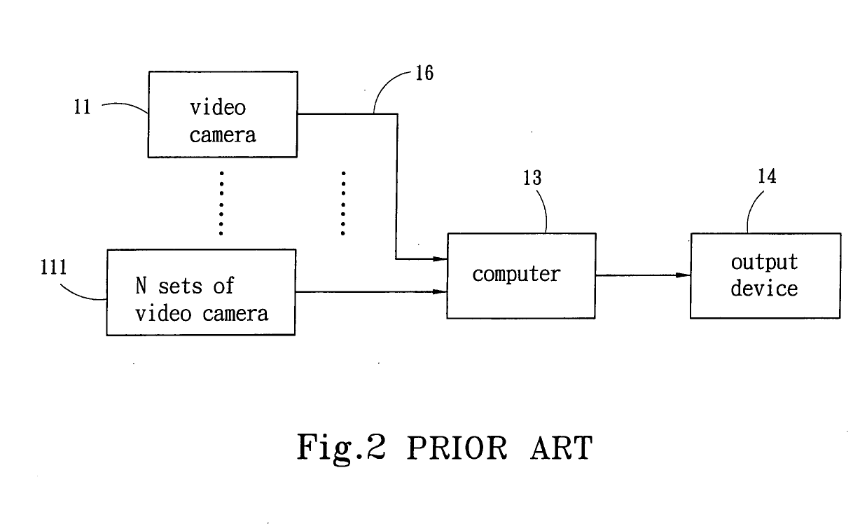

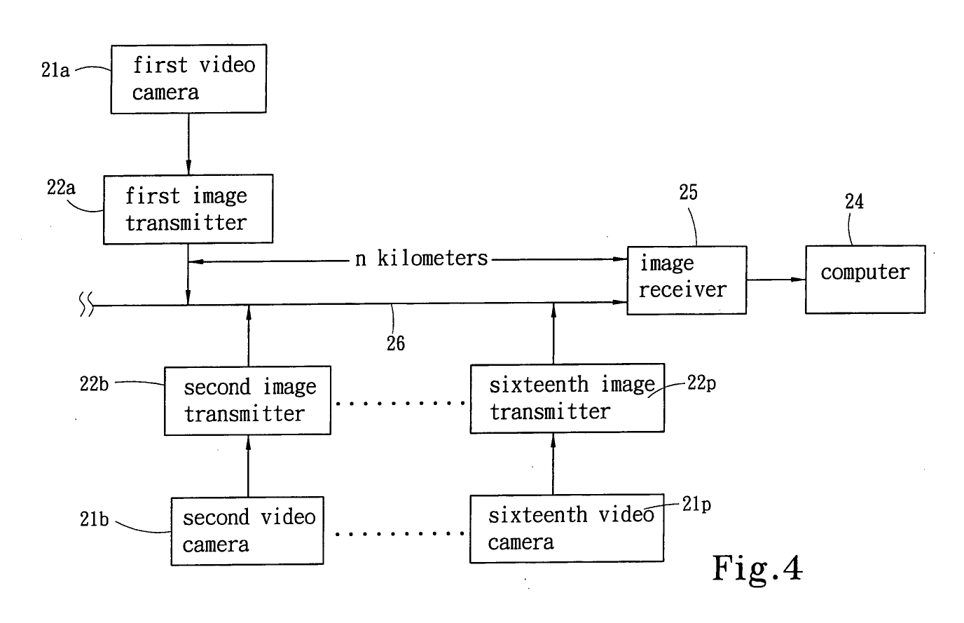

Referring to FIG. 4, another preferred application of present invention, wherein the image transmitters 22a to 22p of the present invention, the video cameras 21a to 21p and the computer 24 are collocated. As shown in FIG. 4, the first video camera 21a is connected to one end of the first image transmitter 22a, the other end of the first image transmitter 22a is connected to an image receiver 25 and the computer 24 via coaxial cable 26 (or existing wiring, such as electrical power wiring, optical fiber and telephone wiring). The connection between the next two video cameras 21b to 21p is similar to the above-mentioned connection of the first video camera 21a. Each video camera corresponds to one image transmitter 22a to 22p. The single axial cable 26 is simultaneously connected to sixteen sets of video cameras 21a to 21p. The image transmitters 22a to 22p of the present invention improve the arrangement of conventional wiring that each video camera is respectively provided with one coaxial cable (shown in FIG. 1A), and the coaxial cable 26 can be expanded to n kilometers (about 6 kilometers), and the transmitting quality of the coaxial cable is the same as that of optical fiber during transmission over a long distance. The cost of coaxial cable is less than that of optical fiber, and the construction of coaxial cable is easier. Each image transmitter 22a to 22p provides each video camera 21a to 21p with one set of IP address. When the computer 24 issues a command, the control unit 225 of the image transmitter 22 controls the image sensor 21 by utilizing the corresponding IP address (shown in FIG. 3B) and further simultaneously controls the plurality of video cameras 21a to 21p.

Although the invention has been explained in relation to its preferred embodiment, it is not used to limit the invention. It is to be understood that many other possible modifications and variations can be made by those skilled in the art without departing from the spirit and scope of the invention as hereinafter claimed.

1. An image transmitter for transmitting image signals picked up by an image sensor through original wiring to a computer at a terminal end, comprising:
an image converting unit for converting the image signal picked up by said image sensor to digital image data;
an image compressing unit for receiving said digital image data and then compressing said digital image data by utilizing image compressing technology;
a packet processing unit for packing said compressed digital image data to a packet of said image data; and
a communication modulating/demodulating unit for transmitting the packet of said image data through said original wiring to said computer at said terminal end by radio frequency modulation.

2. The image transmitter according to claim 1, wherein the frequency of said image data is 20 MHz after said image data are modulated by said communication modulating/demodulating unit, and said transmitting speed is extreme 14 Mbps.

3. The image transmitter according to claim 1, wherein said communication modulating/demodulating unit provides said capacity of image data with 16 bits.

4. The image transmitter according to claim 1, wherein said communication modulating/demodulating unit provides said capacity of image data with 16 sets of IP addresses.

5. An image transmitter for following a command signal issued by a computer at a remote end and then controlling an image sensor through original wiring, comprising:
an image converting unit for converting image signal picked up by said image sensor to digital image data;
an image compressing unit for receiving said digital image data and then compressing said digital image data by utilizing image compressing technology;
a packet processing unit for packing and unpacking said image data and said command signal during transmitting and packing said compressed digital image data to a packet of said image data;
a communication modulating/demodulating unit for transmitting said packet of said image data through said original wiring to said computer at a remote end by frequency modulation; and
a control unit for following said command issued by said computer and then controlling the image sensor.

6. The image transmitter according to claim 5, wherein said control unit controls said depth of field of said image sensor.

7. The image transmitter according to claim 5, wherein said control unit controls said monitoring angle of said image sensor.

8. The image transmitter according to claim 5, wherein said control unit controls said focal distance of said image sensor.
